(19) United States
(12) Patent Application Publication
(10) Pub. No.: US 2005/0094882 A1
(43) Pub. Date: May 5, 2005

(54) Rebalancing compression predictors

(76) Inventor: Dana D. Jacobsen, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/699,728

(22) Filed: Nov. 3, 2003

(51) Int. Cl. G06K 9/36; G06K 9/46; H04N 1/32

(52) U.S. Cl. 382/239; 382/244; 358/426.01

(57) ABSTRACT

Systems, methods and devices for dynamically rebalancing pixel predictors in a compressor are provided. A method includes tracking a pool of pixel predictors. A subset of pixel predictors from the tracked pool is selected. The subset is periodically rebalanced to locally adapt to image conditions.

Compression algorithms are used for data storage and transmission. Data compression can occur as either lossless or lossy compression. Lossless data compression results in compression and decompression without data loss. Lossy compression provides high degrees of compression and results in very small compressed files, but there is a certain amount of data loss when data are restored, though typically the visual degradation is imperceptible. Lossless data compression is used in situations where data loss is not tolerated. However, lossless data compression typically does not produce compressed file sizes as small as that obtained through lossy compression.

To increase data compression efficiency, two-dimensional image compressors have been developed. One issue encountered with two-dimensional image compressors is their reliance on fixed predictors as part of their algorithms. Reliance on fixed predictors may result in the use of sub-optimal predictors for some files and for some areas within files.

### BRIEF DESCRIPTION OF THE DRAWINGS

FIG. 1A is an embodiment of a printing device.

FIG. 1B is another embodiment of a printing device.

FIG. 2A illustrates a block diagram of an embodiment of electronic components for a data compression/decompression.

FIG. 2B illustrates an embodiment of pixel predictors.

FIG. 2C illustrates an embodiment of a table of hit counts for pixel predictors.

FIG. 2D illustrates another embodiment of a table of hit counts for pixel predictors.

FIG. 3 illustrates a block diagram embodiment of electronic components for a printing device.

FIG. 4 illustrates a method embodiment.

FIG. 5 illustrates another method embodiment.

FIG. 6 illustrates another method embodiment.

FIG. 7 illustrates a system embodiment.

### DETAILED DESCRIPTION

Embodiments of the invention provide techniques for data compression using predictors to allow better image compression. Various embodiments of the invention provide the ability to update pixel predictor usages in two-dimensional image compressors and rebalance pixel predictor identifiers as their usage frequency changes. Embodiments, however, are not limited to two-dimensional applications. Rebalancing pixel predictor identifiers can increase the likelihood of a predictor match and thus can allow pixel predictors to adapt to local image conditions. Embodiments can provide greater data compression than compression techniques using fixed predictors.

For the purpose of the present disclosure, data compression is discussed in association with compressing image files. Embodiments, however, are not so limited. Images can be defined as digital image files such as digital photographs, computer generated graphics, rasterized images to be printed and the like. Image files operated on by various embodiments of the invention can be captured or created through devices such as digital cameras, scanners, or desktop computers, among others. Image files can also include text, either incorporated into the image or associated with graphics as text blocks.

Embodiments of the invention include devices, methods, computer executable instructions (e.g., software), operable on devices, and systems described herein. Embodiments of the invention, however, are not limited to any particular programming language or device.

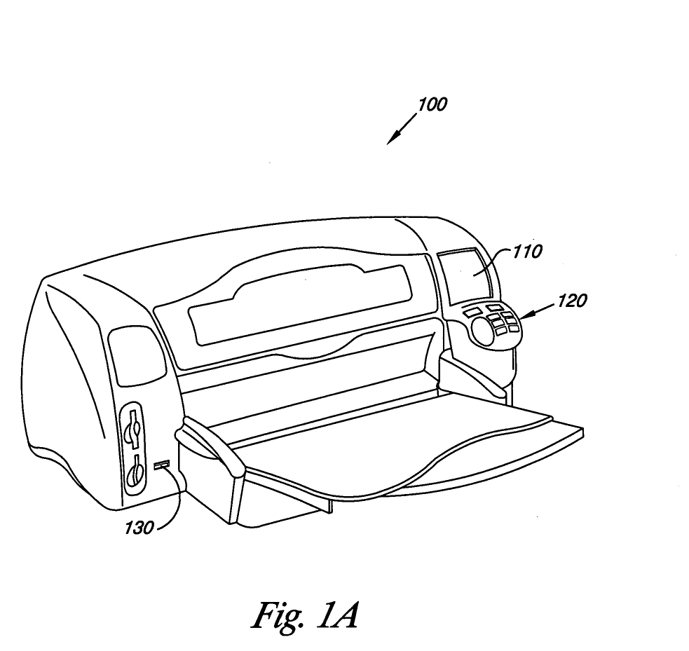

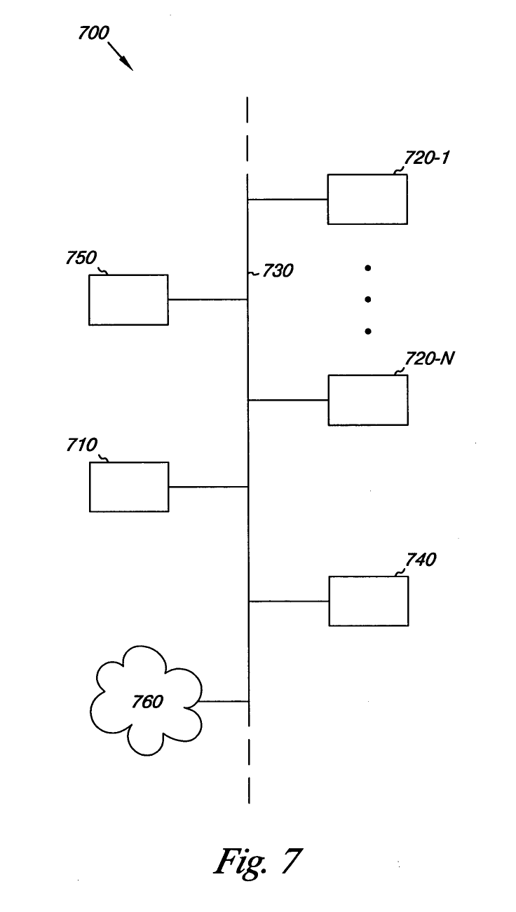

FIG. 1A provides a perspective illustration of an embodiment of a printing device 100, such as an inkjet printer, which is operable to implement or which can include embodiments of the invention. The embodiment of FIG. 1A illustrates an inkjet printer 100, which can be used in an office or home environment for business reports, correspondence, desktop publishing, pictures, and the like. However, embodiments of the invention are not so limited and can include other devices implementing various embodiments of the invention. The printing device 100 illustrated in the embodiment of FIG. 1A can operate as a stand alone device and/or can be used as a printing device in a system, such as the printing device 740 shown in the system environment 700 of FIG. 7. As illustrated in FIG. 1A, an embodiment of the printing device 100 can include a display 110 to preview image data, a keypad 120 for data entry and an I/O port 130 for receiving data from other devices.

FIG. 1B illustrates an embodiment of a laser printing device 150. The laser printing device 150 can include those components identified with FIG. 1A, however printing device 150 includes a laser printing mechanism versus an inkjet printing mechanism. In the embodiment shown in FIG. 1B, the printing device 150 includes a console 160 and a print media supply tray 170. The console 160 can be used to enter information into the printing device 150.

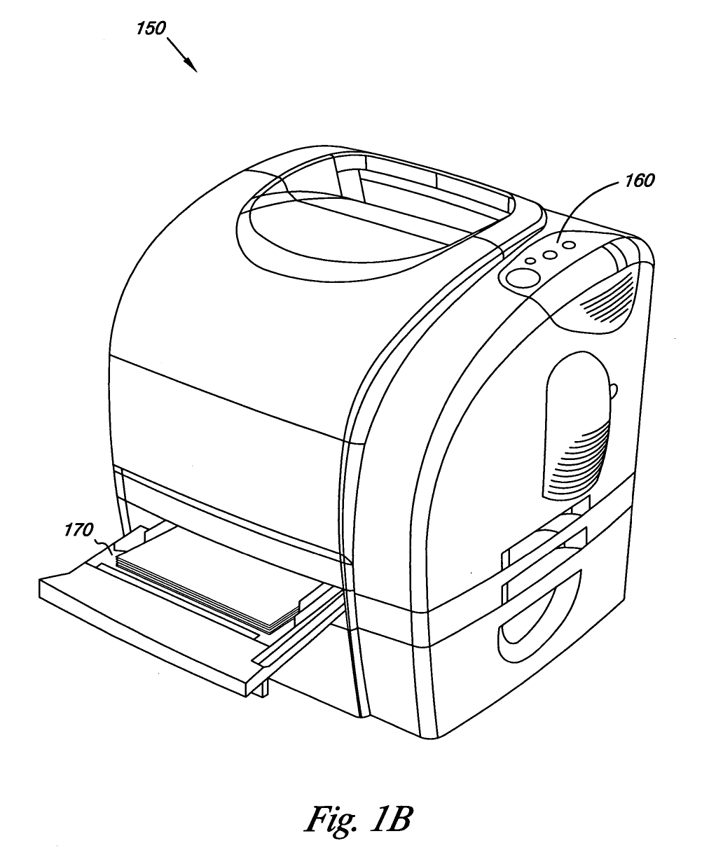

FIG. 2A illustrates a block diagram of an embodiment of electronic components for a data compression/decompression. FIG. 2A illustrates a processor 210 coupled to a memory 220. Memory 220 can include some combination of ROM, dynamic RAM, magnetic media, and optically read media, and/or some type of non-volatile and writeable memory such as battery-backed memory or flash memory. An I/O port 230 and a compression/decompression module 240 are illustrated coupled to the processor 210. The processor 210 can operate on data received from the compression/decompression module 240, software (e.g., computer executable instructions) and/or data stored in the memory 220 or received via the I/O port 230. The executable instructions can carry out various control steps and functions for a printing device. Software is also provided to perform embodiments of the invention.

The compression/decompression module 240 is operable on software embodiments to perform two-dimensional image compression and decompression with predictor rebalancing. Compression and decompression functions can be combined in a single module or a separate decompression module can be provided. Embodiments of the invention are not so limited. Although FIG. 2A illustrates a separate module for performing compression/decompression functions, in various embodiments, the processor 210, operating on firmware or software instructions, can perform two-dimensional image compression and decompression with predictor rebalancing. Embodiments, however, are not limited to two-dimensional usage.

FIG. 2B illustrates an embodiment of image processing of pixels in an image such as can be performed using the components described above. One of ordinary skill in the art will understand the various techniques available for processing pixels in an image. FIG. 2B illustrate a pixel “Z” as the present pixel being operated on. FIG. 2B further illustrates an embodiment of a set, or “pool”, of pixel predictors which can be used by the compression/decompression module 240 for compressing data, e.g., image data. As will be explained in more detail below, a number of different compression and decompression algorithms can be employed by module 240. Embodiments of the invention are not so limited.

The location of various pixels in an image being processed can be referenced in various manners such as by using Cartesian coordinates, or as illustrated in this example, geographically relative to the present pixel “Z” being processed. Thus, in this example, the pool of pixel predictors are referenced geographically as North West-West (NWW), North West (NW), North (N), North East (NE), North East-East (NEE), West-West (WW), and West (W) of the pixel “Z” being processed. As one of ordinary skill in the art will appreciate upon reading this disclosure, other possible predictors can include a “last unmatched” predictor, a cache predictor, a black predictor (e.g., a black pixel value), a white predictor (e.g., a white pixel value), and a “most common” predictor. The “last unmatched” predictor is defined as the last pixel value that was encoded verbatim. The cache predictor is defined as the last pixel of the literal string or horizontal run of pixel values. Literal strings or horizontal runs of pixel values are described in co-pending Published U.S. Patent Application US2003-0184809A1, by Clouthier et al., entitled “Grayscale and Binary Image Data Compression”. The “most common” predictor is defined as the pixel value most frequently found in the image or local section of the image being processed. Embodiments for the pool of pixel predictors is not, however, limited to the predictors listed here as examples. In various embodiments, a subset of the pool of predictors can be selected and used for subsequent pixel predictions.

As mentioned above, a number of compression and decompression algorithms can be used by module 240 shown in FIG. 2. By way of example and not by way of limitation, these compression algorithms can include continuous tone prediction algorithms, e.g., LOCO, MED, LINEAR 4, LINEAR 5, and GAP, as the same will be known and understood by one of ordinary skill in the art. Continuous tone prediction algorithms are described, for example, in U.S. Pat. No. 5,764,374, Seroussi et al. “System and Method for Lossless Image Compression having Improved Sequential Determination of Golomb Parameter.” According to various embodiments of the present invention, the pixel predictors can include compression algorithms. That is, a number of compression algorithms can be tracked as to their closeness in predicting pixel values. As will be explained in more detail below, software embodiments are operable to track the closeness of a compression algorithm in predicting an actual pixel value of a pixel being processed and, based on which of the compression algorithms achieved the closest predictions, the software can alternate between the compression algorithms being used in the image compression process. In this manner actual compression algorithms are being referenced and switched as the pixel predictors associated with compressing an image or local section of the image.

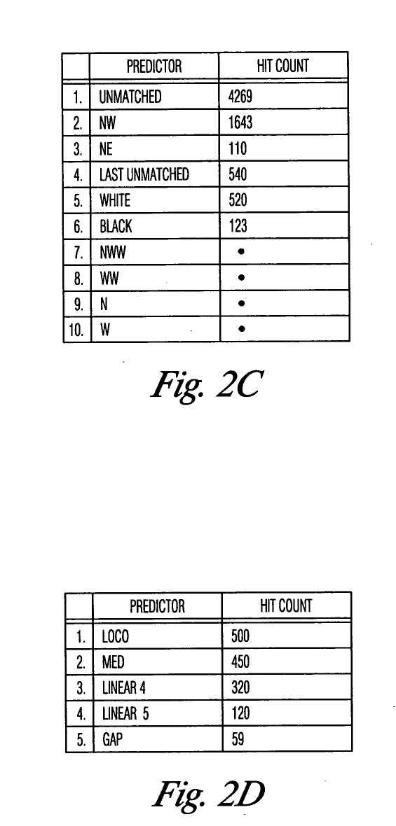

FIG. 2C illustrates an embodiment of a table of hit counts for pixel predictors. As described in more detail in connection with FIGS. 4-6 hit counters can be assigned to the pixel predictors described above. Hit counters are known and understood by one of ordinary skill in the art. The hit counters can be incremented based on matches between the pixel predictors and processed pixels. The pixel predictor with the highest incremented hit counter may then be the first predictor applied in subsequent predictions. The next highest incremented hit counter can be applied as the second predictor and so forth. If no match is found between a pixel predictor and a processed pixel then an “unmatched” hit counter can be incremented and the location of that pixel encoded as the “last unmatched” predictor. Thus, FIG. 2C illustrates a number of pixel predictors in a pool of pixel predictors ordered in a hierarchy from 1 to 10. In the example of FIG. 2C, the predictors are unmatched, NW, NE, last unmatched, white, black, NWW, WW, N, and W arranged in that order based on the respective incremented value, or hit count, held by the hit counters assigned to each. As will be described in more detail below, the software embodiments can periodically rebalance the pixel predictor hierarchy, e.g., the pixel predictor's order of use in the rank of 1 to 10, based on the value in the hit counters. Additionally, the software embodiments can periodically rebalance the pixel predictor hit counters. For example, the software can periodically divide the value in a hit counter by a power of 2. Embodiments of the invention are not, however, limited to these examples.

FIG. 2D illustrates another embodiment of a table of hit counts for pixel predictors. In the embodiment of FIG. 2D, the pixel predictors are compression algorithms as the same has been suggested above. As shown in FIG. 2D, the pool of pixel predictors ordered in a hierarchy from 1 to 5. In the example of FIG. 2D, the predictors are various compression algorithms such as LOCO, MED, LINEAR 4, LINEAR 5, and GAP arranged in that order based on the respective incremented value, or hit count, held by the hit counters assigned to each. As noted above, software embodiments can be used to track the closeness of a compression algorithm in predicting actual pixel values for pixels being processed in an image or local portion of an image and, based on which of the compression algorithms achieved the closest predictions, the hit counters can be incremented to reflect the accuracy or closeness of the compression algorithm. The software embodiments can periodically switch or alternate between the compression algorithms being used in the image compression process, and rebalance the pixel predictor hierarchy, e.g., the pixel predictor's order of use in the rank of 1 to 5, based on the value in the hit counters. And, as described in connection with FIG. 2C, the software embodiments can periodically rebalance the pixel predictor hit counters such as by dividing by a power of two.

As one of ordinary skill in the art will appreciate from reference to FIG. 2C, a subset of the pool of predictors shown, e.g., predictors number 1 through 3, can be used in particular compression algorithm and the subset can periodically be rebalanced by the software embodiments, e.g., to change to predictors in the 1 through 3 hierarchy, based on the value in the hit counters. However, in the embodiment of FIG. 2D, one compression algorithm being used for predicting pixel values in compressing and image or portion of an image would continue to be used until the compression was replaced in the hierarchy from the number 1 rank according to another compression algorithm having a higher incremented value in its hit counter.

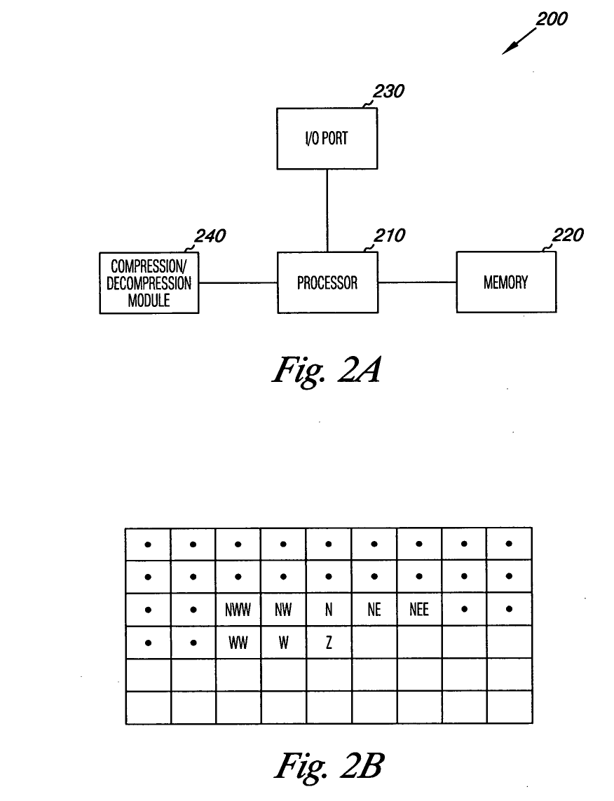

FIG. 3 illustrates a block diagram embodiment of electronic components for a printing device 350, such as printer 100 shown in FIG. 1 or printer 150 in FIG. 1B, as can be used with embodiments of the present invention. As shown in FIG. 3, the electronic components 350 include a printhead 355. The electronic components 350 include control logic in the form of executable instructions which can be stored in a memory 360 and can be operated on by a controller or a processor 365. The processor 365 is operable to execute computer executable instructions received from the memory 360. The executable instructions carry out various control steps and functions for a printer. The executable instructions are operable to perform embodiments of the invention described herein.

FIG. 3 illustrates a printhead driver 370, a carriage motor driver 375, and a media motor driver 380 coupled to interface electronics 385 for moving the printhead 355 and media, and for firing individual nozzles. The printhead driver 370, the carriage motor driver 375, and the media motor driver 380 can be independent components or combined on one or more application specific integrated circuits (ASICs). The embodiments, however, are not so limited. Computer executable instructions, or routines, can be executed by these components. As shown in the embodiment of FIG. 3, the interface electronics 385 interface between control logic components and the electromechanical components of the printer such as the printhead 355.

The processor 365 can be interfaced, or connected, to receive instructions and data from a remote device (e.g. host computer), such as 720-1 to 720-N shown in FIG. 7, through one or more I/O channels 390. The one or more I/O channels 390 can include a parallel or serial communications port, and/or a wireless interface for receiving information, e.g. print job data and image data files.

The processor 365 can be interfaced with a compression/decompression module 395 having software, e.g. computer executable instructions, for rebalancing pixel predictors according to the embodiments described herein. The compression/decompression module 395, together with the processor 365 can execute the computer executable instructions to perform two-dimensional image compression with pixel predictor rebalancing. In various embodiments, the processor 365 can perform the functions of the compression/decompression module 395. In such embodiments, the processor 365, operating on computer executable instructions, can perform two-dimensional image compression with pixel predictor rebalancing. Embodiments, however, are not limited to two-dimensional usage.

FIGS. 4, 5 and 6 illustrate various method embodiments which provide for two-dimensional lossless image compression with pixel predictor rebalancing. According to various embodiments described herein, two-dimensional image compression with pixel predictor rebalancing allows enhanced image compression and decompression for image file printing. The methods described herein can be performed by software (e.g. computer executable instructions) operable on the systems and devices shown herein or otherwise. The embodiments of the invention, however, are not limited to any particular operating environment or to software written in a particular programming language. Unless explicitly stated, the method embodiments described herein are not constrained to a particular order or sequence. Additionally, some of the described method embodiments or elements thereof can occur or be performed at the same point in time.

FIG. 4 illustrates a method embodiment 400 of the invention for two-dimensional lossless image compression with pixel predictor rebalancing. The method embodiment 400 can include tracking pixel predictors in two dimensions using applied hit counters, as shown at block 410. Compressors use command groups which encode runs or a number of literals as the same is known and understood by one of ordinary skill in the art, in an attempt to save space by using a few bits to represent a much larger pixel value. In some cases 2-bits can be used for an 8-bit pixel value and in other cases 3-bits may be used to represent a 32-bit pixel value. Embodiments, however, are not limited to the above example. There are many possible choices for predictors and various compression algorithms use different sets of predictors. Better predictions yield better compression. Embodiments of the present invention periodically rebalance the set of pixel predictors and/or rebalance a subset of pixel predictors to adapt to local conditions in an image.

In FIG. 2C, an example of the possible pixel predictors is provided, e.g., unmatched, NW, NE, last unmatched, white, black, NWW, WW, N, and W. Software embodiments can modify the compression/decompression coding such that the typical command byte and the mechanism for storing counts is replaced by a bit packing mechanism, and the location, run count, and replacement count are stored as variable length codes (e.g., unary codes, Gamma coded, and Golomb codes) as the same will be known and understood by one of ordinary skill in the art. Thus, a large set of pixel predictors can be tracked as shown by the example list above. After each prediction is performed, all predictors in the set, or pool of predictors can be examined by the software and a predictor which provides a match has its associated hit counter incremented.

According to embodiments, a subset of pixel predictors from among the pool of pixel predictors is selected and this subset is then used for pixel prediction. Based on the above examination, after each prediction the top “N” predictors, e.g., the subset of predictors with the highest hit counts in their associated hit counters, are selected for use in the prediction of the next pixel being processed. The designator “N” is intended to indicate that any number chosen of the subset of predictors based on a particular implementation, e.g., three predictors represented by 2-bits can be used for an 8-bit pixel value and seven predictors represented by 3-bits may be used to represent a 32-bit pixel value. (N²=0-3 and N³=0-7). In the above example, three and seven are identified since one predictor value is generally reserved to indicate no prediction matched. These top “N” predictors will indicate the predictor locations, e.g., NW, NE, last unmatched, white, black, NWW, WW, N, and W, which have been most successful in matching past pixel values. It is understood by one of ordinary skill in the art that a variable length coding compressor (e.g., using unary codes, Gamma coded, and Golomb codes, etc.) may not have a fixed limit on the number of predictors that can be used. However, it may still be advantageous to use the software embodiments described herein to rebalance a subset of pixel predictors from among the pool of pixel predictors as the number of bits allocated to rarely matched predictors may not justify the memory resource allocation such as on a printing device.

Pixel predictor hit counters can be incremented based on matches between pixel predictors and processed pixels, as shown in block 420. If no match is found between the pixel predictor subset and the pixel being processed no pixel predictor number is incremented. In addition, the pixel being processed will be encoded verbatim as an unmatched pixel value. The software embodiments will then update this pixel location to be tracked going forward as the “last unmatched” pixel predictor. The pixel predictor with the highest incremented hit counter can be the first predictor applied in subsequent predictions. Similarly, the pixel predictor with the next highest incremented hit counter can be applied as the second predictor, and so forth. The software embodiments periodically rebalance the subset of pixel predictors to rearrange the hierarchy of the pixel predictor usage, based on the value in the hit counters, in order to efficiently process those predictors with a likelihood of providing a match.

According to various embodiments, when the highest incremented pixel predictor value reaches a specific threshold, the pixel predictor hit counter values can be rebalanced, as shown in block 430, e.g., by dividing by a power of two. The specific threshold may be fixed, image-specific, and/or user-defined. Without the rebalancing embodiments of the present invention, e.g., if no rebalancing were performed, a pixel predictor chosen may be globally the best in an imaging process, but may not have a very good match success rate for the current image or portion of the image. This rebalancing embodiment of periodically dividing the hit counters by some number can be performed after each line of pixels being process and/or after each pixel prediction. Software embodiments are further operable to examine the specific threshold occasionally to determine whether the threshold should be reset to another value.

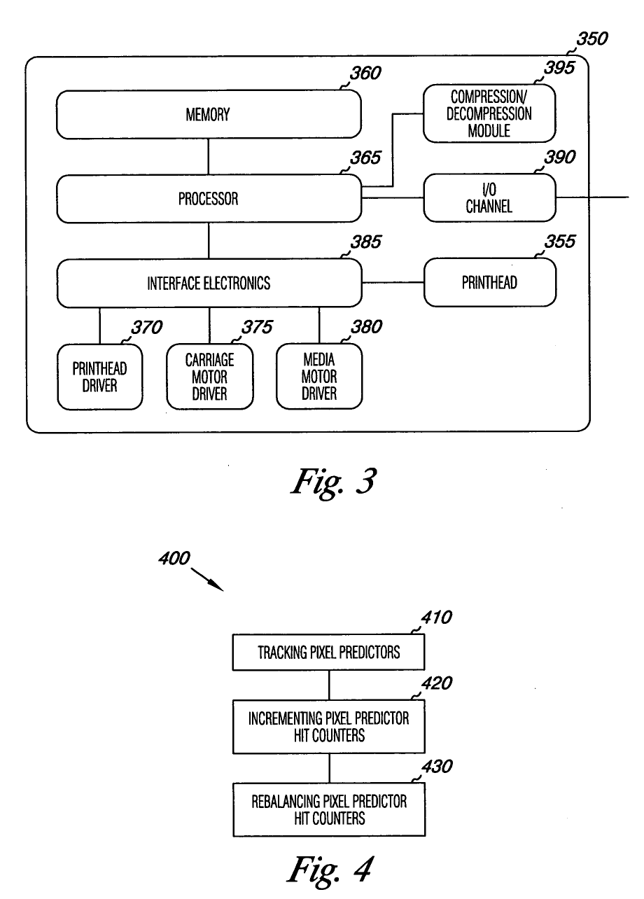

FIG. 5 illustrates another method embodiment of the invention. This method embodiment includes implementing image compression using variable length code algorithms, as shown at block 510. Various algorithms, such as fixed and variable length code algorithms can be used to communicate pixel information such as a number of pixel prediction values. Pixel predictor locations, run counts and replacement counts can be stored as variable length code where a single bit is output to indicate a run command; a single bit is output to indicate a literal command; pixel predictor locations are unary coded; a run count is encoded as variable length Gamma Golomb (3) code; a replacement count is encoded as variable length Gamma Golomb (3) code; and an unmatched pixel is coded verbatim. This example is provided by way of illustration and not by way of limitation.

Hit counters can be assigned to pixel predictors as shown in block 520. Pixel predictor matches to processed pixels may be tracked (e.g., in two-dimensions), as shown in block 530. Pixel predictor hit counters can be incremented based on matches between pixel predictors and processed pixels, as shown in block 540. The pixel predictor hit counters can maintain a total number of increments representing the number of matches found. The pixel predictor with the highest incremented hit counter total may then be the first predictor applied in subsequent predictions, the next highest is the second predictor, and so forth. If no match is found between a pixel predictor and a processed pixel, then no hit counters are incremented. As described in connection with FIG. 4, in the case of no match the pixel being processed will be encoded verbatim as an unmatched pixel value. The software embodiments will then update this pixel location to be tracked going forward as the “last unmatched” pixel predictor.

As described in connection with FIG. 4, the software embodiments can periodically rebalance the subset of pixel predictors to rearrange the hierarchy of the pixel predictor usage as shown in block 550, based on the value in the hit counters in order to efficiently process those predictors with a likelihood of providing a match. Additionally, the software can periodically rebalance the hit counters by dividing by a number such as a power of two in order to further increase prediction efficiency.

Those skilled in the art will understand that embodiments of the invention can also be implemented in “fixed-bit code” (e.g., versus variable length code), two-dimensional image compressors as described in co-pending Published U.S. Patent Application US2003-0184809A1, Clouthier et al., “Grayscale and Binary Image Data Compression.” An example of a method embodiment can include implementation in a fixed 8-bit, two-dimensional compressor with 2 bits available for processing pixel prediction.

In a method embodiment implemented in a fixed-bit, two-dimensional compressor, pixel predictor hit counters can be assigned as described in the above examples. Bit limits for encoding an indicator of a run, encoding a literal command, encoding a prediction of the next pixel, encoding a seedrow count, and encoding a replacement count can be specified, as the same will be known and understood by one of ordinary skill in the art. Pixel predictor use can then be tracked in two dimensions and hit counters can be incremented based on processed pixel matches.

In an embodiment of the invention implemented in an 8-bit “fixed-bit” compressor with 2 bits available for processing pixel prediction, three possible prediction values are allowed (locations NE, W, and cache, for example, as described above). One possible prediction value is reserved to indicate no prediction matched the pixel being processed. Thus, a subset of pixel predictors from among a pool of possible predictors is chosen. The three pixel predictor values with the highest incremented hit counters may be picked as the subset for use in the next prediction. The pixel predictor with the highest incremented hit counter may be the first predictor applied in subsequent predictions, the pixel predictor with the next highest incremented hit counter may be the second predictor applied, and so forth. Use of the pixel predictor with the highest incremented hit counter may enhance the efficiency of subsequent predictions within the same image locality. Software embodiments can periodically examine the subset of pixel predictors to confirm whether the three pixel predictors from among the pool still have the highest incremented hit counters. If not, the software can change the subset of pixel predictors being used from among the pool of pixel predictors. Unlike in the use of the variable length code embodiments, as long as the subset of pixel predictors maintain the highest incremented hit counters it may not be relevant to reorder the hierarchy within the subset since only three pixel predictors are being processed versus potentially many more in variable length code embodiments.

As described in connection with FIG. 4, when the highest incremented pixel predictor value reaches a specific threshold, the pixel predictor hit counter values can be rebalanced to allow for local adaptation to image conditions.

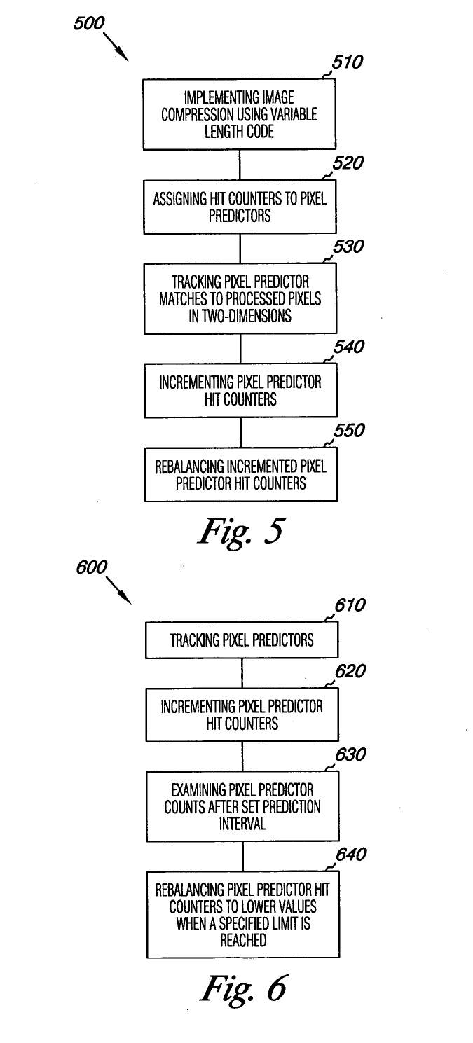

FIG. 6 illustrates another method embodiment of the invention. As shown in block 610, pixel predictors are tracked in two dimensions using assigned hit counters. Pixel predictor hit counters are incremented based on matches to processed pixels as shown in block 620. The pixel predictor with the highest incremented hit counter may be the first predictor used to process subsequent pixel predictions and so forth as described above.

After a user definable and/or set interval, the incremented pixel predictor counts may be examined as shown in block 630. Pixel predictor hit counters can be rebalanced to lower values when a specific threshold value in the hit counters, e.g., whether user defined, image specific, or fixed, is reached as shown in block 640. Rebalancing can occur by dividing all pixel predictor hit counters by the same factor. However, embodiments of the invention are not so limited.

FIG. 7 illustrates an embodiment of a printing device 710 networked in a system environment 700. The printing device 710 can include a printing device having software for rebalancing predictors as the same have been described herein. In the embodiment of FIG. 7, the system printing device 710 is illustrated networked to a number of remote devices, 720-1 to 720-N, via a number of data links 730. As illustrated in FIG. 7, the printing device can further be connected to other peripheral devices 740, e.g., other scanning device or fax capable devices, to a storage device 750, and to Internet access 760. The remote devices, 720-1 to 720-N, can include a desktop computer, laptop computer, a workstation, a server, a hand held device, e.g., a wireless phone, a personal digital assistant (PDA), or other devices as the same will be known and understood by one of ordinary skill in the art.

The number of data links 730 can include one or more physical connections, one or more wireless connections, and/or any combination thereof. The networked system environment shown in FIG. 7 can include any number of network types including, but not limited to, a Local Area Network (LAN), a Wide Area Network (WAN), a Personal Area Network (PAN), and a Wireless-Fidelity (Wi-Fi) network, among others.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the invention.

It is to be understood that the above description has been made in an illustrative fashion, and not a restrictive one. Combination of the above embodiments, and other embodiments not specifically described herein will be apparent to those of skill in the art upon reviewing the above description. The scope of the various embodiments of the invention includes any other applications in the above structures and methods are used. Therefore, the scope of various embodiments of the invention should be determined with reference to the appended claims, along with the full range of equivalents to which such claims are entitled.

In the foregoing Detailed Description, various features are grouped together in a single embodiment for the purpose of streamlining the disclosure. This method of disclosure in not to be interpreted as reflecting an intention that the embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. A method of image compression, comprising:
tracking a pool of pixel predictors;
selecting a subset of pixel predictors from the tracked pool; and
rebalancing the pixel predictor subset to locally adapt to image conditions.

2. The method of claim 1, wherein the pool of pixel predictors are assigned hit counters which are used to facilitate rebalancing.

3. The method of claim 1, wherein the pool of pixel predictors are tracked in two dimensions.

4. The method of claim 3, wherein the pool of pixel predictors include pixel locations.

5. The method of claim 4, wherein the pixel locations include a NE, a NEE, a NW, a N, a NWW, a W, and a WW pixel location expressed geographically relative to a pixel being processed.

6. The method of claim 1, wherein the pool of pixel predictors includes a last unmatched pixel, a cache pixel, a black pixel, a white pixel and a most common value pixel.

7. The method of claim 1, wherein the pool of pixel predictors tracked include continuous tone prediction algorithms.

8. The method of claim 7, wherein the continuous tone predictions algorithms are selected from the group of LOCO, MED, LINEAR 4, LINEAR 5 and GAP.

9. The method of claim 1, wherein the method further includes incrementing a hit counter associated with each pixel predictor in the pool of pixel predictors when a match between a pixel predictor and processed pixel is found.

10. The method of claim 9, wherein the subset of possible pixel predictors is selected based on incremented hit counters.

11. The method of claim 10, further including using a pixel predictor from the selected subset having a highest incremented hit counter value as the first pixel predictor used for pixel predictions.

12. The method of claim 11, further including periodically rebalancing the hit counters.

13. The method of claim 12, further including rebalancing the selected subset after a set prediction interval, and rebalancing the hit counters when a first pixel predictor in the subset exceeds a specified limit.

14. A method of image compression, comprising:
communicating a number of pixel prediction values via a variable length code compression algorithm;
assigning a hit counter to each of a number of pixel predictors, each pixel predictor having one of the pixel prediction values;
tracking matches between pixel predictor values and a number of processed pixels in two dimensions;
incrementing the hit counters based on tracked prediction matches; and
selecting a number of pixel predictors having the highest hit counters for future pixel predictions.

15. The method of claim 14, wherein the method further comprises:
storing the incremented hit counters in a bit packing mechanism; and
storing a number of run counts and replacement counts as variable length code.

16. The method of claim 15, wherein a single bit is encoded to indicate a run command.

17. The method of claim 15, wherein a single bit is encoded to indicate a literal command.

18. The method of claim 15, wherein each pixel predictor includes a pixel predictor location that is unary coded.

19. The method of claim 15, wherein each run count is encoded as variable length Gamma Golomb (3) code.

20. The method of claim 15, wherein each replacement count is encoded as variable length Gamma Golomb (3) code.

21. The method of claim 14, wherein the method further includes encoding a last unmatched pixel prediction verbatim.

22. A method of image compression, comprising:
assigning a hit counter to each of a number of pixel predictor values;
tracking matched between pixel predictor values and processed pixels in two dimensions;
incrementing the hit counters based on tracked prediction matches; and
rebalancing the hit counters to locally adapt to image conditions.

23. The method of claim 22, wherein the method further includes communicating a number of pixel prediction values via a variable length code compression algorithm.

24. The method of claim 22, wherein the method further includes communicating a number of pixel prediction values via a fixed-bit code compression algorithm.

25. The method of claim 22, further comprising:
specifying a number of bit limits for encoding an indicator of a run command;
encoding a literal command;
encoding a prediction of a next pixel;
encoding a seedrow count; and
encoding a replacement count.

26. A computer readable medium having instructions for causing a device to perform a method of image compression, comprising:
assigning a hit counter to each of a number of pixel predictor values;
tracking matched between pixel predictor values and processed pixels in two dimensions;
incrementing the hit counters based on tracked prediction matches; and
rebalancing the hit counters to locally adapt to image conditions.

27. The computer readable medium of claim 26, wherein the method further includes communicating a number of pixel prediction values via a variable length code compression algorithm.

28. The computer readable medium of claim 26, wherein the method further includes communicating a number of pixel prediction values via a fixed-bit code compression algorithm.

29. The computer readable medium of claim 26, the method further comprising:
specifying a number of bit limits for encoding an indicator of a run command;
encoding a literal command;
encoding a prediction of a next pixel;
encoding a seedrow count; and
encoding a replacement count.

30. An imaging forming system, comprising:
a processor;
a memory;
a media marking mechanism;
interface electronics coupling the processor, the memory, and the media marking mechanism;
means for receiving compressed image data; and
means for two-dimensional image compression/decompression with pixel predictor rebalancing.

31. The system of claim 30, wherein the means for receiving image data includes a set of computer executable instructions operable on an image file format.

32. The system of claim 30, wherein the means for receiving the image data includes an I/O connection to send and receive image data.

33. The system of claim 30, wherein the means for image file compression/decompression includes a set of computer executable instructions for two-dimensional compression/decompression with dynamic pixel predictor rebalancing.

34. An image compression device, comprising:
a processor;
a memory operably coupled to the processor;
a compression module coupled to the processor and the memory;
an I/O port to send and receive data coupled to the processor and the memory; and
logic on the device to conduct two-dimensional image compression with a number of pixel predictors.

35. The device of claim 34, wherein the device includes a number of hit counters, each associated with a different pixel predictor, the hit counters operable to be incremented when a match between a pixel predictor and processed pixel is found.

36. The device of claim 35, wherein at least one hit counter can be periodically reset.

37. The device of claim 36, wherein each hit counter has a total and wherein the total can be reset by dividing the total by a power of two.

38. The device of claim 34, wherein the number of pixel predictors are selected from the group including a number of set of pixel values and a number of compression algorithms.
